(19) United States
(12) Patent Application Publication
(10) Pub. No.: US 2018/0351333 A1
(43) Pub. Date: Dec. 6, 2018

(54) METHOD OF TESTING A SPARK PLUG, AND A TESTING STATION THEREFOR

(71) Applicant: Fives Cinetic Corp., Farmington Hills, MI (US)

(72) Inventor: John Philip Gagneur, Westland, MI (US)

(73) Assignee: Fives Cinetic Corp., Farmington Hills, MI (US)

(21) Appl. No.: 15/613,553

(22) Filed: Jun. 5, 2017

(51) Int. Cl. H01T 13/60; F02P 17/12

(52) U.S. Cl. CPC H01T 13/60; F02P 2017/121; F02P 17/12

(57) ABSTRACT

A method of testing a spark plug includes exciting the spark plug with a constant current from a DC power supply. A voltage difference across a gap of the spark plug is measured with a voltage measuring device. A status of an element of the spark plug is determined from the measured voltage difference. The status of the element of the spark plug may include, but is not limited to, a distance of the gap of the spark plug, or a condition of an insulator of the center electrode of the spark plug.

### TECHNICAL FIELD

The disclosure generally relates to a method of testing a spark plug, and a testing station for testing a spark plug.

### BACKGROUND

A spark plug is a key component in the proper functionality of an Otto cycle engine. It is important that a gap of the spark plug is properly set for proper engine operation. The gap of the spark plug is the distance between a center electrode of the spark plug and a side electrode of the spark plug. If the gap is too narrow, the spark across the gap may be too weak to ignite the combustion gases. In contrast, a gap that is too wide may prevent a spark between the electrodes, thereby failing to ignite the combustion gasses. Accordingly it is important to properly set the gap of the spark plug.

Manufacturers may test the spark plug to ensure that the gap is properly set after installation in an engine. Current industry practice for production measurement of the gap uses ignition coil excitation to generate the necessary high voltage to ionize the air between the center electrode and the side electrode. The arc pulses are extremely short in duration, e.g., 300 to 500 nanoseconds typically. This requires the use of a high speed computer and complex analysis algorithms to extract an estimate of the gap by analyzing the fly-back voltage from the ignition coil windings. The parasitic side effects of the inductive coil properties makes up approximately 85% of the signal that is analyzed, which significantly degrades the gap measurement resolution.

### SUMMARY

A method of testing a spark plug is provided. The method includes exciting the spark plug with a constant current from a DC power supply. A voltage difference across a gap of the spark plug is measured with a voltage measuring device. The gap of the spark plug is a distance between a center electrode of the spark plug and a side electrode of the spark plug. A status of an element of the spark plug is determined from the measured voltage difference. The status of the element of the spark plug may include, but is not limited to, a distance of the gap of the spark plug, or a condition of an insulator of the center electrode of the spark plug.

A method of testing a spark plug is also provided. The method includes applying a constant direct current to a center electrode of the spark plug. A voltage difference between the center electrode of the spark plug and a side electrode of the spark plug, which is generated by the constant direct current applied to the center electrode, is measured. A gap distance between the center electrode and the side electrode is then calculated from the measured voltage difference between the center electrode and the side electrode.

A testing station for testing a spark plug is also provided. The testing station includes a DC power supply having a positive terminal and a negative terminal. The DC power supply is operable to supply a constant direct current of electricity. A connector is attached to one of the positive terminal or the negative terminal of the DC power supply. The connector is configured for attachment to one of a center electrode or a side electrode of a spark plug. A voltage measuring device is electrically connected to the connector. The voltage measuring device is operable to sense a voltage difference across a gap of the spark plug. The gap of the spark plug is a distance between the center electrode of the spark plug and a side electrode of the spark plug.

Accordingly, the use of the steady state constant current from the DC power supply as the excitation source produces a continuous excitation. The continuous excitation provides a measurement signal that contains approximately 99% gap data, compared to the approximately 15% gap data included in the data signal from prior art impulse signal excitation. The steady state constant current used for the excitation source therefore provides a much more accurate test signal. Additionally, because the excitation is continuous, the process described herein does not require high speed measurement equipment to analyze the test signal.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic diagram of a test station for testing a spark plug.

FIG. 2 is a flowchart representing a method of testing the spark plug.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

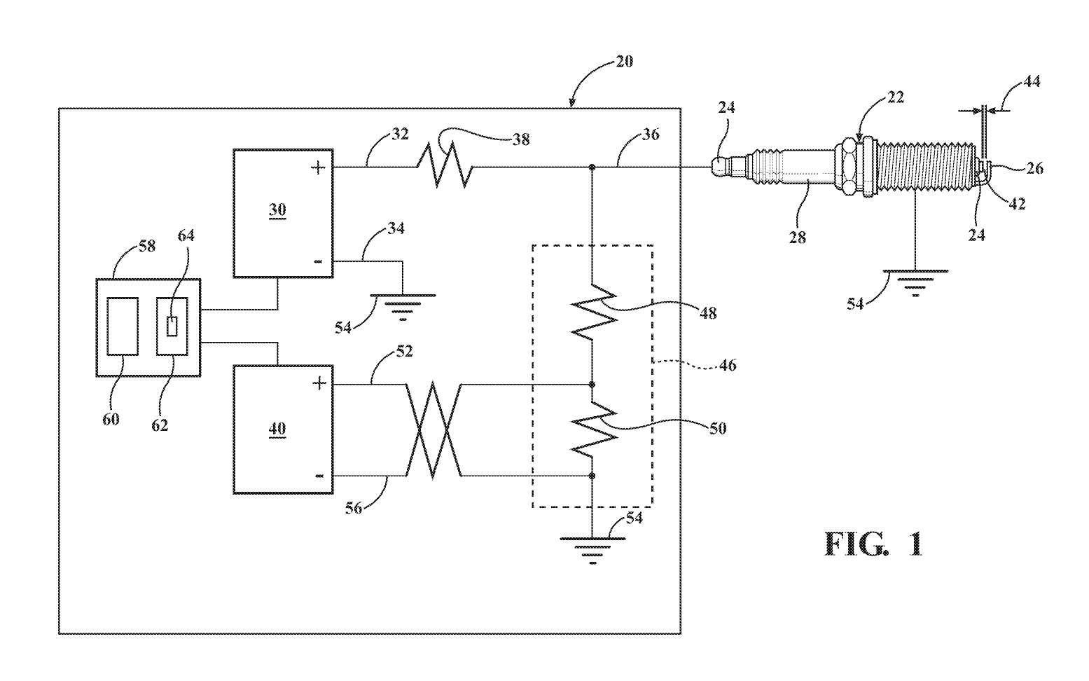

Referring to the Figures, wherein like numerals indicate like parts throughout the several views, a testing station is generally shown at 20. The testing station 20 is used for testing a spark plug 22. Referring to FIG. 1, the spark plug 22 may include, but is not limited to, any type, size, style, or configuration suitable for use in an Otto cycle, internal combustion engine. The spark plug 22 includes a center electrode 24 and a side electrode 26. In one embodiment, the center electrode 24 is configured for attachment to a power source, and the side electrode 26 is configured for attachment to a ground. In another embodiment, the center electrode 24 is configured for attachment to a ground, and the side electrode 26 is configured for attachment to a power source. Typically, a spark plug 22 wire may be attached to the center electrode 24 to supply electricity to the center electrode 24, and the side electrode 26 is grounded through the engine. An insulator 28 separates the center electrode 24 from the side electrode 26.

Referring to FIG. 1, the testing station 20 includes a DC power supply 30. The DC power supply 30 includes a load or positive terminal 32 and a ground or negative terminal 34. The DC power supply 30 may include any device that is capable of providing a constant direct current of electricity to the positive terminal 32. The specific construction and operation of suitable DC power supplies are well known to those skilled in the art, are readily available, and are therefore not described in detail herein.

Referring to FIG. 1, the testing station 20 further includes a connector 36. In one embodiment, the connector 36 is attached to the positive terminal 32 of the DC power supply 30, and is configured for attachment to one of the center electrode 24 or the side electrode 26 of the spark plug 22. In another embodiment, the connector 36 is attached to the negative terminal 34 of the DC power supply 30, and is configured for attachment to one of the center electrode 24 or the side electrode 26 of the spark plug 22. For example, the connector 36 may include an end terminal that connects to the center electrode 24 of the spark plug 22 in the same manner that a spark plug 22 wire does. The connector 36 may include, but is not limited to, a cable or wire, but may include other devices or structures capable of conducting an electrical current. The connector 36 may include a series ballast resistor 38. The series ballast resistor 38 stabilizes ringing in the connector 36. The specific resistance of the series ballast resistor 38 will depend on the length of the connector 36 and the internal resistance of the connector 36. Suitable series ballast resistors 38 are well known in the art, are readily available, and are therefore not described in detail herein.

Referring to FIG. 1, the testing station 20 further includes a voltage measuring device 40. The voltage measuring device 40 is electrically connected to the connector 36, and is operable to sense a voltage difference across a gap 42 of the spark plug 22. As is appreciated by those skilled in the art, the gap 42 of the spark plug 22 is a distance 44 between the center electrode 24 of the spark plug 22 and a side electrode 26 of the spark plug 22. The voltage measuring device 40 may include any device capable of measuring a direct current voltage. The specific configuration and operation of suitable voltage measuring devices 40 are well known to those skilled in the art, are readily available, and are therefore not described in detail herein.

The voltage measuring device 40 may be connected to the connector 36 through a voltage divider 46. Referring to FIG. 1, the voltage divider 46 is disposed between the voltage measuring device 40 and the connector 36. Additionally, the voltage divider 46 is attached to the connector 36 between the series ballast resistor 38 and the center electrode 24 of the spark plug 22. The voltage divider 46 may include any device that is capable of converting a large voltage into a smaller voltage. For example, as shown in FIG. 1, the voltage divider 46 includes a first resistor 48 and a second resistor 50, with the first resistor 48 having a resistance that is significantly higher than the second resistor 50. In one exemplary embodiment, a positive terminal 52 of the voltage measuring device 40 is connected to the circuit between the first resistor 48 and the second resistor 50 of the voltage divider 46. Suitable voltage dividers 46 are well known in the art, are readily available, and are therefore not described in detail herein.

Referring to FIG. 1, a common ground 54 interconnects one of the positive terminal 32 or the negative terminal 34 of the DC power supply 30, and one of a negative terminal 56 and the positive terminal 52 of the voltage measuring device 40. Additionally, the common ground 54 is configured for electrical connection to one of the center electrode 24 or the side electrode 26 of the spark plug 22. In the exemplary embodiment shown in the Figures and described herein, the negative terminal 34 of the DC power supply 30, the negative terminal 56 of the voltage measuring device 40, and the side electrode 26 of the spark plug 22, are all connected to the common ground 54. It should be appreciated that the side electrode 26 of the spark plug 22 may be connected to the common ground 54 directly, or alternatively, may be connected to the common ground 54 through some other intermediate component. For example, a wire attached to the common ground 54 may be connected to an engine block or cylinder head supporting the spark plug 22, thereby connecting the side electrode 26 of the spark plug 22 to the common ground 54. As such, the spark plug 22 may be tested when installed in an engine, or may be tested independent of the engine.

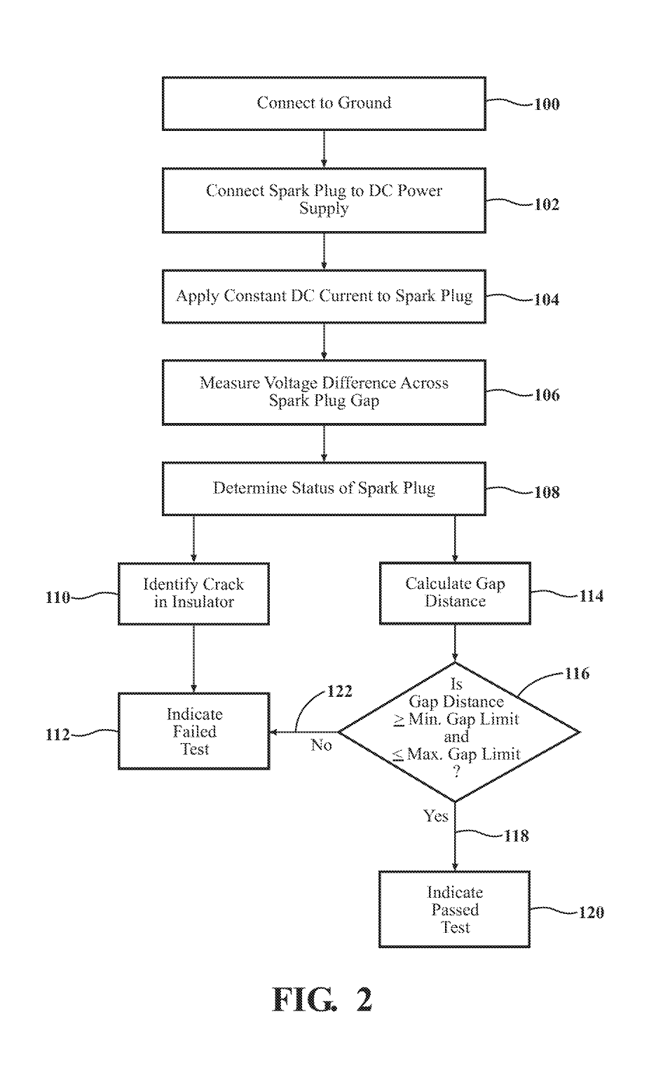

Referring to FIG. 1, the testing station 20 may further include a testing controller 58. The testing controller 58 is disposed in communication with the DC power supply 30 and the voltage measuring device 40. The testing controller 58 is operable to communicate with and control the operation of both the DC power supply 30 and the voltage measuring device 40. The testing controller 58 may include a computer and/or processor, and include all software, hardware, memory, algorithms, connections, sensors, etc., necessary to manage and control the operation of the DC power supply 30 and the voltage measuring device 40. The testing controller 58 may be referred to as a controller, a control module, a computer, etc. A method, described below and generally shown in FIG. 2, may be embodied as a program or algorithm operable on the testing controller 58. It should be appreciated that the testing controller 58 may include any device capable of analyzing data from various sensors, comparing data, making the necessary decisions required to control the operation of the DC power supply 30 and the voltage measuring device 40, and executing the required tasks necessary to implement the method of testing the spark plug 22 described below.

The testing controller 58 may be embodied as one or multiple digital computers or host machines each having one or more processors 60, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The testing controller 58 includes tangible, non-transitory memory 62 on which are recorded computer-executable instructions, including a spark plug 22 testing algorithm 64. The processor 60 of the testing controller 58 is configured for executing the spark plug 22 testing algorithm 64. The spark plug 22 testing algorithm 64 may at least partially implement the method of testing the spark plug 22 described below.

Referring to FIG. 2, the method of testing the spark plug 22 includes connecting one of the center electrode 24 or the side electrode 26 of the spark plug 22, one of the positive terminal 52 or the negative terminal 56 of the voltage measuring device 40, and one of the positive terminal 32 or the negative terminal 34 of the DC power supply 30 to the common ground 54. It should be appreciated that the components will all be connected as either a positive ground system, or a negative ground system, as understood by those skilled in the art. The exemplary embodiment shown in the Figures and described herein shows the system connected in a negative ground system. However, the scope of the claims should not be limited to the negative ground system described herein. The step of connecting the components to the common ground 54 is generally indicated by box 100 in FIG. 2. As noted above, the spark plug 22 may be tested when installed in an engine or other device, or may be tested in a stand-alone manner. A test operator may connect the common ground 54 to the spark plug 22 in any suitable manner. For example, if the common ground 54 is equipped with an alligator clip, then the operator may clamp the alligator clip onto a metal threaded portion of the spark plug 22, which is connected to the side electrode 26 of the spark plug 22, or may alternatively clamp the alligator clip onto an engine in which the spark plug 22 is installed. It should be appreciated that the common ground 54 may be attached to the center electrode 24 or the side electrode 26 of the spark plug 22 in some other manner not described herein. In the exemplary embodiment described herein, the negative terminal 34 of the DC power supply 30 and the negative terminal 56 of the voltage measuring device 40 may be connected to the common ground 54 in a similar manner. Alternatively, the negative terminal 34 of the DC power supply 30 and the negative terminal 56 of the voltage measuring device 40 may be permanently wired to the common ground 54.

Once all components are connected to the common ground 54, the test operator may then connect the DC power supply 30 to the one of the center electrode 24 or the side electrode 26 of the spark plug 22, with the connector 36. In the exemplary embodiment described herein, the DC Power supply 30 is connected to the center electrode 24. The step of connecting the spark plug 22 to the DC power supply 30 is generally indicated by box 102 in FIG. 2. In the exemplary embodiment described herein, the test operator may connect the positive terminal 32 of the DC power supply 30 to the center electrode 24 of the spark plug 22 with the connector 36, as described above. Alternatively, it should be appreciated that the DC power supply 30 may be connected to the center electrode 24 of the spark plug 22 in some other manner not described herein, that enables the DC power supply 30 to provide a constant direct current of electricity to the center electrode 24 of the spark plug 22.

Once the positive or load terminal of the DC power supply 30 is connected to the center electrode 24 of the spark plug 22, the test operator may instruct the testing controller 58 to begin the testing sequence. The testing controller 58 may then engage the DC power supply 30 to apply a constant direct current to the center electrode 24 of the spark plug 22, through the connector 36. The step of applying the constant direct current to the spark plug 22 is generally indicated by box 104 in FIG. 2. As noted above, the series ballast resistor 38 in the connector 36 stabilizes ringing in the connector 36, while the constant direct current continuously excites the spark plug 22.

A voltage difference across the gap 42 of the spark plug 22 is measured during the continuous excitation of the spark plug 22 in response to the constant direct current applied by the DC power supply 30. The step of measuring the voltage difference is generally indicated by box 106 in FIG. 2. The voltage difference is measured with the voltage measuring device 40. As noted above, the testing station 20 may be equipped with the voltage divider 46 to reduce the voltage between the spark plug 22 and the voltage measuring device 40.

The testing controller 58 may use the measured voltage difference to determine a status of an element of the spark plug 22. The step of determining the status of an element of the spark plug 22 is generally indicated by box 108 in FIG. 2. For example, in one embodiment, the testing controller 58 may analyze the measured voltage difference to identify a crack in the insulator 28 of the spark plug 22. The step of identifying a crack in the insulator 28 is generally indicated by box 110 in FIG. 2. If a crack in the insulator 28 is identified, the testing controller 58 may indicate a testing failure of the spark plug 22. The step of indicating a testing failure of the spark plug 22 is generally indicated by box 112 in FIG. 2.

In another embodiment, the testing controller 58 may analyze the measured voltage difference to determine and/or calculate a gap distance 44 between the center electrode 24 of the spark plug 22 and the side electrode 26 of the spark plug 22. The step of calculating the gap distance 44 is generally indicated by box 114 in FIG. 2. The voltage difference is a function of the gap distance 44 between the center electrode 24 and the side electrode 26, and a dielectric strength of ambient air between the center electrode 24 and the side electrode 26. The dielectric strength of the ambient air does not change or vary enough to greatly affect the measured voltage between the center electrode 24 and the side electrode 26, and so may be ignored for the purposes of calculating the gap distance 44. Since the measured voltage difference is dependent upon the gap distance 44, calculating and/or determining the gap distance 44 of the spark plug 22 may include correlating the measured voltage difference to the gap distance 44. Correlating the gap distance 44 to the measured voltage difference may be done in any suitable manner. For example, through empirical testing, a look-up table may be developed and saved in the memory of the testing controller 58. The look-up table may output a gap distance 44 for a specific value of the measured voltage difference. Alternatively, correlating the gap distance 44 to the measured voltage difference may include converting the measured voltage difference to engineering gap units using a polynomial function.

Once the testing controller 58 has calculated or determined the gap distance 44, the testing controller 58 may compare the calculated gap distance 44 to a maximum gap limit and a minimum gap limit. The maximum gap limit is the maximum distance of the gap 42, i.e., the maximum allowable distance that the center electrode 24 may be spaced from the side electrode 26. The minimum gap limit is the minimum distance of the gap 42, i.e., the minimum allowable distance that the center electrode 24 may be spaced from the side electrode 26. If the gap 42 is less than the minimum gap distance, or greater than the maximum gap distance, the spark plug 22 may not properly ignite the combustion gases. The testing controller 58 compares the gap distance 44 to the maximum gap limit and the minimum gap limit in order to determine if the gap distance 44 is less than the minimum gap limit, if the gap distance 44 is greater than the maximum gap limit, or if the gap distance 44 is equal to or greater than the minimum gap limit and equal to or less than the maximum gap limit. The step of comparing the calculated gap distance 44 to the minimum gap limit and the maximum gap limit is generally indicated by box 116 in FIG. 2.

When the testing controller 58 determines that the gap distance 44 is equal to or greater than the minimum gap limit and equal to or less than the maximum gap limit, generally indicated at 118, then the testing controller 58 may indicate a passed test. The step of indicating a passed test is generally indicated by box 120 in FIG. 2. When the testing controller 58 determines that the gap distance 44 is less than the minimum gap limit or that the gap distance 44 is greater than the maximum gap limit, generally indicate at 122, then the testing controller 58 may indicated a failed test. The step of indicated a failed test is generally indicated by box 112 in FIG. 2. A passed test and/or a failed test may be indicated in any suitable manner. For example, the testing controller 58, may illuminate a green light for a passed test, and illuminate a red light for a failed test. Alternatively, the testing controller 58, may produce a first sound for a failed test and a second sound for a passed test. It should be appreciated that the failed test and the passed test may be indicated in any suitable manner, and may be indicated in some other manner not described herein.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of testing a spark plug, the method comprising:
exciting the spark plug with a constant current from a DC power supply;
measuring a voltage difference across a gap of the spark plug, with a voltage measuring device, wherein the gap of the spark plug is a distance between a center electrode of the spark plug and a side electrode of the spark plug; and
determining a status of an element of the spark plug from the measured voltage difference.

2. The method set forth in claim 1, wherein determining the status of the element of the spark plug from the measured voltage difference includes determining a gap distance of the spark plug.

3. The method set forth in claim 2, wherein determining the gap distance of the spark plug includes correlating the measured voltage difference to the gap distance of the spark plug.

4. The method set forth in claim 3, wherein correlating the measured voltage difference to the gap distance of the spark plug includes converting the measured voltage difference to engineering gap units using a polynomial function.

5. The method set forth in claim 2, further comprising comparing the gap distance to a maximum gap limit and a minimum gap limit to determine if the gap distance is less than the minimum gap limit, if the gap distance is greater than the maximum gap limit, or if the gap distance is equal to or greater than the minimum gap limit and equal to or less than the maximum gap limit.

6. The method set forth in claim 5, further comprising indicating a passed test when the gap distance is equal to or greater than the minimum gap limit and equal to or less than the maximum gap limit.

7. The method set forth in claim 5, further comprising indicating a failed test when the gap distance is less than the minimum gap limit or greater than the maximum gap limit.

8. The method set forth in claim 1, further comprising reducing the voltage between the spark plug and the voltage measuring device with a voltage divider.

9. The method set forth in claim 1, further comprising connecting one of the side electrode or the center electrode of the spark plug, a negative terminal of the voltage measuring device, and one of a positive terminal or a negative terminal of the DC power supply to a common ground.

10. The method set forth in claim 1, further comprising connecting the DC power supply to one of the center electrode or the side electrode of the spark plug with a connector.

11. The method set forth in claim 10, wherein the connector includes a series ballast resistor.

12. The method set forth in claim 1, wherein determining a status of the element of the spark plug from the measured voltage difference includes identifying a crack in an insulator of the spark plug from the measured voltage difference.

13. A method of testing a spark plug, the method comprising:
applying a constant direct current to one of a center electrode or a side electrode of the spark plug;
measuring a voltage difference between the center electrode of the spark plug and the side electrode of the spark plug, generated by the applied constant direct current; and
calculating a gap distance between the center electrode and the side electrode from the measured voltage difference between the center electrode and the side electrode.

14. The method set forth in claim 13, further comprising comparing the calculated gap distance to a maximum gap limit and a minimum gap limit to determine if the gap distance is less than the minimum gap limit, greater than the maximum gap limit, or equal to or greater than the minimum gap limit and equal to or less than the maximum gap limit.

15. The method set forth in claim 14, further comprising indicating a passed test when the gap distance is equal to or greater than the minimum gap limit and equal to or less than the maximum gap limit.

16. The method set forth in claim 14, further comprising indicating a failed test when the gap distance is less than the minimum gap limit or greater than the maximum gap limit.

17. The method set forth in claim 13, wherein calculating the gap distance includes converting the measured voltage difference to engineering gap units using a polynomial function.

18. A testing station for testing a spark plug, the testing station comprising:
a DC power supply having a positive terminal and a negative terminal, and operable to supply a constant direct current of electricity;
a connector attached to one of the positive terminal or the negative terminal of the DC power supply and configured for attachment to one of a center electrode or a side electrode of a spark plug; and
a voltage measuring device electrically connected to the connector and operable to sense a voltage difference across a gap of the spark plug, wherein the gap of the spark plug is a distance between the center electrode of the spark plug and a side electrode of the spark plug.

19. The testing station set forth in claim 18, further comprising a voltage divider disposed between the voltage measuring device and the connector.

20. The testing station set forth in claim 18, wherein the connector includes a series ballast resistor.

21. The testing station set forth in claim 18, further comprising a common ground interconnecting one of the positive terminal or the negative terminal of the DC power supply, a negative terminal of the voltage measuring device, and wherein the common ground is configured for electrical connection to one of the center electrode or the side electrode of the spark plug.

22. The testing station set forth in claim 18, further comprising a testing controller in communication with the DC power supply and the voltage measuring device, wherein the testing controller includes a processor and a memory having a spark plug testing algorithm stored thereon, wherein the processor is operable to execute the spark plug testing algorithm to:
control the DC power supply to apply a constant direct current to the spark plug;
control the voltage measurement device to measure a voltage difference across the gap of the spark plug;
calculate a gap distance of the gap from the voltage difference across the gap of the spark plug;
compare the calculated gap distance to a maximum gap limit and a minimum gap limit
indicate a passed test when the calculated gap distance is between the maximum gap limit and the minimum gap limit; and
indicate a failed test when the calculated gap distance is not between the maximum gap limit and the minimum gap limit.
